(19) United States
(12) Patent Application Publication
(10) Pub. No.: US 2017/0067857 A1
(43) Pub. Date: Mar. 9, 2017

(54) ULTRASONIC INSPECTION APPARATUS, ULTRASONIC INSPECTION SYSTEM, AND ULTRASONIC INSPECTION METHOD

(71) Applicant: HITACHI POWER SOLUTIONS CO., LTD., Ibaraki (JP)

(72) Inventors: Katsuhiko OONUKI, Hitachi-shi (JP); Kaoru KITAMI, Hitachi-shi (JP); Masafumi TAKADA, Hitachi-shi (JP); Seiya MINAKAWA, Hitachi-shi (JP)

(73) Assignee: HITACHI POWER SOLUTIONS CO., LTD., Ibaraki (JP)

(21) Appl. No.: 15/255,302

(22) Filed: Sep. 2, 2016

(30) Foreign Application Priority Data
Sep. 4, 2015 (JP) 2015-174476

(51) Int. Cl. G01N 29/28

(52) U.S. Cl. CPC G01N 29/28; G01N 2291/102; G01N 2291/0289

(57) ABSTRACT

To minimize contact between water and a work piece that should avoid water and obtain good images in ultrasonic inspection, an ultrasonic probe that irradiates a work piece with an ultrasonic wave and receives reflected wave thereof, an X and Y-axis driving devices that allow the ultrasonic probe 21 to scan the work piece in a horizontal direction, a Z-axis driving device that moves up and down the ultrasonic probe with respect to the work piece, a water supply part provided in the ultrasonic probe and supplying water in a predetermined amount between the probe tip end portion and the work piece, and a water suction part provided in the ultrasonic probe and suctioning the water after water supply by the water is supplied are provided.

### CROSS-REFERENCE TO RELATED APPLICATION

This application is based upon and claims priority from the Japanese Patent Application No. 2015-174476, filed on Sep. 4, 2015, the entire contents of which are incorporated herein by reference.

### BACKGROUND OF THE INVENTION

1. Field of the Invention

This invention relates to an ultrasonic inspection apparatus, an ultrasonic inspection system, and an ultrasonic inspection method.

2. Description of the Related Art

As a background art of the technical field, there is JP-A-2014-6177 (PTL 1). The literature describes “scanning means that can perform scanning in horizontal directions, height adjustment means in vertical directions attached to the scanning means, a holder attached to the height adjustment means, an ultrasonic probe attached to the holder, a nozzle attachment that flows out water from the nozzle and forms a continuous water flow from the ultrasonic probe to a work piece, and gap adjustment means that is attached to the height adjustment means or the holder and can move the nozzle attachment in the vertical directions are provided” (see Abstract).

Further, as a background art of the technical field, there is JP-A-2008-8745 (PTL 2). The literature describes “in an ultrasonic probe main body and a probe holder, a fabric bag body is provided in contact with an ultrasonic transmitting and receiving surface of the ultrasonic probe main body and polymer absorbers are housed in the bag body. When water is supplied to the polymer absorbers from a water supply pipe, the polymer absorbers absorb water and swell to fill the bag body and expand the bag body. The excess water flows out of the bag body and is drained from a drain pipe. Under the condition, with the bag body pressed against a subject, ultrasonic flaw detection is performed. In this regard, the swelling polymer absorbers closely contact with one another and amounts of reflection of ultrasonic wave on their interfaces are extremely small, and the transmission state of ultrasonic wave is nearly the same as that of transmission in water” (see Abstract).

### SUMMARY OF THE INVENTION

In inspection of a semiconductor wafer using an ultrasonic inspection apparatus, water is supplied to the entire area of the surface to be inspected.

However, recently, in view of characteristics of semiconductor devices, it is desirable to wet the devices with water as little as possible, and the need to perform ultrasonic inspection with pinpoint accuracy by locally supplying water has been increasing. The present teachings address this need.

PTL 1 and PTL 2 describe a technology of performing ultrasonic inspection by immersing only a local to be inspected of a work piece.

However, in the technology disclosed in PTL 1, water flows out from the nozzle and the continuous water flow is formed from the ultrasonic probe to the work piece, and there is no means for quickly collecting the water after use. Accordingly, even in the local immersion, there is a defect that the work piece that should avoid water is immersed in a wide area over a long period.

Further, in the technology disclosed in PTL 2, water is allowed to exist between the ultrasonic probe and the work piece via the bag body and accordingly, it is impossible to obtain a good image in ultrasonic inspection because the ultrasonic wave from the ultrasonic probe and reflected wave thereof pass through the bag body.

On this account, the present teachings describe an ultrasonic inspection apparatus, an ultrasonic inspection system, and an ultrasonic inspection method that may minimize contact between water and even a work piece that should avoid water while still obtaining good images in ultrasonic inspection.

According to an aspect of the present teachings, a water supply part that supplies water in a limited predetermined amount between a probe tip end portion of an ultrasonic probe and a work piece and a water suction part that suctions the supplied water after an inspection performed by irradiation of the work piece with ultrasonic wave using the ultrasonic probe is ended are provided in side parts of the ultrasonic probe.

Further, according to another aspect of the present teachings, a water supply step of supplying water in a limited predetermined amount between a probe tip end portion of an ultrasonic probe and a work piece and a water suction step of suctioning the supplied water after an inspection performed by irradiation of the work piece with ultrasonic wave using the ultrasonic probe is ended are provided.

According to the present teachings, contact between water and even a work piece that should avoid water may be minimized and good images may be obtained in ultrasonic inspection.

The other objects, configurations, and effects than those described above will be made clear by the following description of embodiments.

### BRIEF DESCRIPTION OF THE DRAWINGS

FIG. 1 is a block diagram of electrical connection showing an overall configuration of an ultrasonic inspection apparatus as one example.

FIG. 2 is a perspective view for explanation of mechanisms of an X-axis driving device, a Y-axis driving device, and a Z-axis driving device of the ultrasonic inspection apparatus as one example.

FIG. 3 is a flowchart for explanation of an ultrasonic inspection method as one example.

FIG. 4 is a plan view of a screen of a display device of the ultrasonic inspection apparatus as one example.

FIG. 5 is an enlarged longitudinal sectional view for explanation of a step of supplying and suctioning water between an ultrasonic probe of the ultrasonic inspection apparatus as one example and a work piece.

FIG. 6A to 6F are explanatory diagrams chronologically showing operations when a water supply part and a water suction part are fixed to the ultrasonic probe of the ultrasonic inspection apparatus as one example.

FIG. 7A to 7H are explanatory diagram chronologically showing operations when the water supply part and the water suction part individually move up and down with respect to the ultrasonic probe of the ultrasonic inspection apparatus as one example.

FIG. 8 is an explanatory diagram showing an overall configuration of an ultrasonic inspection system as one example.

### DETAILED DESCRIPTION OF THE PREFERRED EMBODIMENTS

As below, examples of the present teachings will be described using the drawings.

An ultrasonic inspection apparatus is an apparatus that irradiates an object to be inspected (work piece) with ultrasonic wave and receives and images reflected wave (or transmitted wave) thereof.

For example, when the work piece is an electronic device, it is necessary to detect flaws such as micro voids and cracks and high resolution is required for the ultrasonic inspection apparatus. In the ultrasonic inspection apparatus, as the frequency of the ultrasonic wave used is increased, a higher resolution may be obtained. However, on the other hand, as the frequency of ultrasonic wave used is increased, the attenuation is larger and the S/N ratio is lower. The degree of attenuation of an ultrasonic wave is smaller in water than that in the air, and accordingly, in a general ultrasonic inspection apparatus of related art, the work piece is immersed in water and ultrasonic inspection is performed with a part between a probe tip end portion and a work piece surface filled with the water.

However, when the work piece is an electronic device or the like that should avoid water, it is desirable to reduce the area in which water adheres to the work piece as much as possible and quickly remove the water from the work piece after the end of the inspection.

In this regard, both the PTL 1 and PTL 2 relate to the technology of performing ultrasonic inspection by immersing only the local to be inspected of the work piece.

However, in the technology disclosed in PTL 1, water flows out from the nozzle and the “continuous” water flow from the ultrasonic probe to the work piece is formed, and there is no means for quickly collecting the water after use. Accordingly, even in the local immersion, there is a defect that the work piece that should avoid water is immersed in a wide area over a long period.

Further, in the technology disclosed in PTL 2, water is allowed to exist between the ultrasonic probe and the work piece via the bag body, and accordingly, there is a defect that it is impossible to obtain a good image in ultrasonic inspection because the ultrasonic wave from the ultrasonic probe and reflected wave thereof pass through the bag body.

On this account, as below, the examples of the teachings that solves the defects of these technologies will be described.

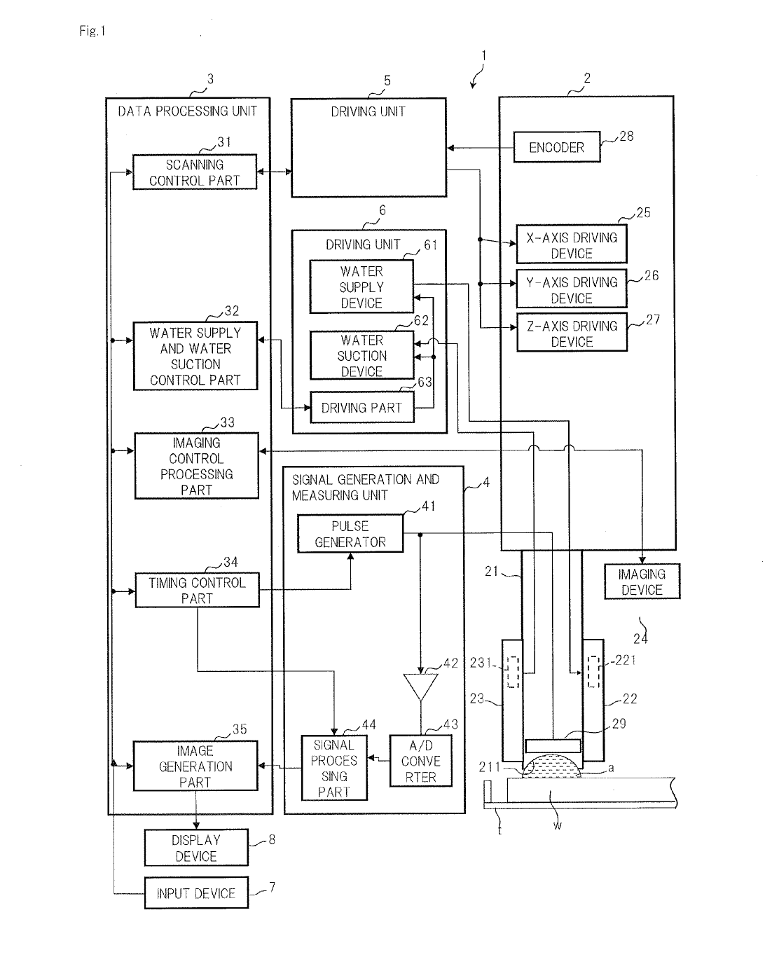

FIG. 1 is a block diagram of electrical connection showing an overall configuration of an ultrasonic inspection apparatus 1 of the example. The ultrasonic inspection apparatus 1 of the example includes an ultrasonic probe unit 2 that performs transmission and reception of ultrasonic waves, etc., a data processing unit 3 that integrally controls the ultrasonic inspection apparatus 1, a signal generation and measuring unit 4 that inputs and outputs electrical signals between the ultrasonic probe unit 2 and itself, driving units 5, 6 that respectively relate to the control of the operation of the ultrasonic probe unit 2, etc.

The ultrasonic probe unit 2 includes an ultrasonic probe 21 with a probe tip end portion 211 downward and an axis direction vertical. The probe tip end portion 211 of the ultrasonic probe 21 has a concave lens shape. The probe tip end portion 211 is formed in the concave lens shape to focus the ultrasonic wave on an observation position for obtaining higher position resolution in the ultrasonic probe 21.

A piezoelectric element 29 is provided in the ultrasonic probe unit 2. The piezoelectric element 29 is formed by attachment of electrodes to respective both surfaces of a piezoelectric membrane formed by e.g. fluorinated copolymer. When a voltage is applied between the electrodes, the piezoelectric element 29 emits an ultrasonic wave from the piezoelectric membrane. The ultrasonic wave is applied to a work piece w from the probe tip end portion 211 of the ultrasonic probe 21. Then, the piezoelectric element 29 receives the reflected wave (echo wave) of the ultrasonic wave from the work piece w and converts the echo wave received by the piezoelectric membrane of the piezoelectric element 29 into a reception signal as a voltage generated between the electrodes.

Here, the work piece w is mounted on a table t and placed below the probe tip end portion 211 of the ultrasonic probe 21. The work piece w is e.g. a semiconductor device manufactured in a semiconductor device manufacturing process and, more specifically, a wafer before divided into individual pieces by dicing.

In side parts of the ultrasonic probe 21, a water supply part 22 that supplies water a (water droplet) in a limited predetermined amount between the probe tip end portion 211 of the ultrasonic probe 21 and the work piece w, and a water suction part 23 that suctions the water a supplied by the water supply part 22. The water supply part 22 is e.g. a member having a nozzle-shaped tip end portion that supplies water a, and the water suction part 23 is e.g. a member having a nozzle-shaped tip end portion that suctions water a. The water supply part 22 and the water suction part 23 provided in the side parts of the ultrasonic probe 21 may be directly provided in the side parts of the ultrasonic probe 21 or provided separately from the side parts in surrounding parts.

An imaging device 24 that moves with the ultrasonic probe 21 and images an image on the work piece w side is provided near the ultrasonic probe 21. The imaging device 24 includes a CCD (charge-coupled device) or the like. The imaging device 24 acquires an image for grasp of overall positions containing the work piece w and the table t with the work piece w mounted thereon or the like.

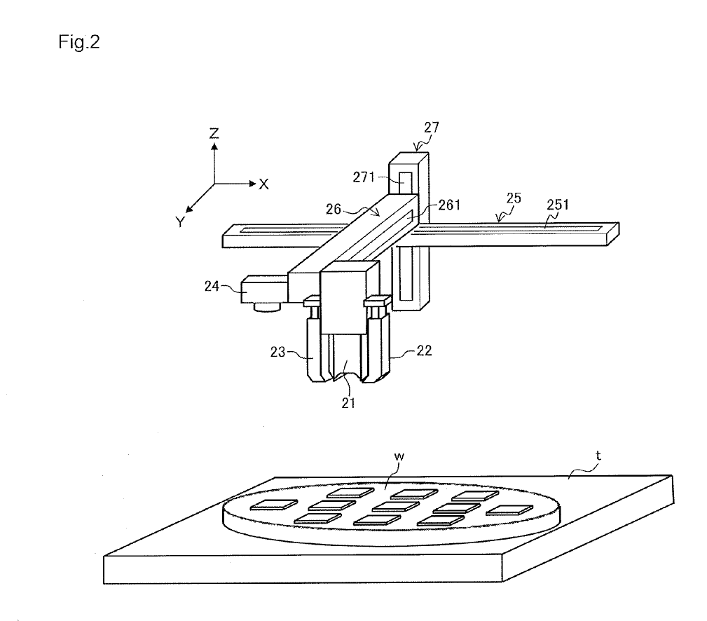

The ultrasonic probe unit 2 includes an X-axis driving device 25 and a Y-axis driving device 26 as scanning devices that move the ultrasonic probe 21 and the imaging device 24 for scanning in horizontal directions (X-direction and Y-direction in FIG. 2) with respect to the work piece w. Further, the ultrasonic probe unit 2 includes a Z-axis driving device 27 as a first elevating device that moves up and down (moves in the Z-direction in FIG. 2) the ultrasonic probe 21 with respect to the work piece w. Furthermore, the ultrasonic probe unit 2 includes an encoder 28 that encodes information of step angles of stepping motors driving the X-axis driving device 25, the Y-axis driving device 26, and the Z-axis driving device 27 and detects amounts of movement with respect to the ultrasonic probe 21 and the imaging device 24 in the X-direction, the Y-direction, and the Z-direction in FIG. 2.

The driving unit 5 drives the X-axis driving device 25, the Y-axis driving device 26, and the Z-axis driving device 27 based on the detection result of the encoder 28 and a command of the data processing unit 3, which will be described later.

The driving unit 6 includes a water supply device 61 and a water suction device 62, and drives the water supply device 61 and the water suction device 62 using a driving part 63. The water supply device 61 includes an electric pump (not shown) and pumps up and supplies water from a water source (not shown) to the water supply part 22. The water suction device 62 includes an electric pump (not shown) and suctions and drains the water a from the water suction part 23 to a drain path (not shown).

The data processing unit 3 includes a microcomputer, a personal computer, or the like and realizes the respective functional parts based on its programs. In other words, the data processing unit 3 includes a scanning control part 31 that controls the scanning position (in the XY-direction in FIG. 2) of the ultrasonic probe unit 2 via the driving unit 5. The scanning control part 31 may move the probe tip end portion 211 of the ultrasonic probe 21 to directly above a predetermined position of the work piece w under the control. The data processing unit 3 includes a water supply and water suction control part 32 that controls water supply to the water supply part 22 and water suction by the water suction part 23 via the driving unit 6. Further, the data processing unit 3 includes an imaging control processing part 33 that controls the imaging device 24 and performs image processing on the image imaged by the imaging device 24. Furthermore, the data processing unit 3 includes a timing control part 34 that controls transmission and reception times of ultrasonic wave and reflected wave thereof by the ultrasonic prove 21, and an image generation part 35 that generates an ultrasonic image based on the reflected wave received by the ultrasonic probe 21 and an imaged image imaged by the imaging device 24.

An input device 7 includes a keyboard, a mouse, a touch panel, etc. and inputs various kinds of data to the data processing unit 3.

A display device 8 includes a liquid crystal display device or the like and displays the ultrasonic image and the imaged image generated by the image generation part 35.

The signal generation and measuring unit 4 includes a pulse generator 41, an amplifier 42, an A/D converter 43, a signal processing part 44.

The pulse generator 41 outputs pulse wave to the piezoelectric element 29 of the ultrasonic probe 21 based on a timing signal output by the timing control part 34.

The amplifier 42 amplifies and outputs the selected reception signal of the piezoelectric element 29 as an output signal.

The A/D converter 43 converts the amplified reception signal from the analog signal into a digital signal.

The signal processing part 44 signal-processes the reception signal. The signal processing part 44 extracts only a part of the reception signal in a predetermined period using gate pulse output by the timing control part 34. The signal processing part 44 outputs amplitude information of the reception signal in the predetermined period or time information of the reception signal in the predetermined period to the image generation part 35. Then, the image generation part 35 generates an ultrasonic image at a predetermined frequency based on the output signal of the signal processing part 44.

FIG. 2 is a perspective view for explanation of mechanisms of the X-axis driving device 25, the Y-axis driving device 26, and the Z-axis driving device 27. The X-axis driving device 25 includes a rail 251 having a longitudinal direction in the X-direction (one direction of the horizontal directions). The X-axis driving device 25 includes a stepping motor (not shown) and a rotation-linear motion conversion mechanism (not shown) that converts the rotation motion of the stepping motor into a linear motion and moves the rail 251. Thereby, the X-axis driving device 25 moves the ultrasonic probe 21 and the imaging device 24 integrated by a predetermined attachment or the like in the X-direction.

The Y-axis driving device 26 and the Z-axis driving device 27 have similar configurations to that of the X-axis driving device 25. That is, the Y-axis driving device 26 has a rail 261 having a longitudinal direction in the Y-direction (one direction of the horizontal directions crossing (orthogonal, for example) the X-direction). The Y-axis driving device 26 includes a stepping motor (not shown) and a rotation-linear motion conversion mechanism (not shown) that converts the rotation motion of the stepping motor into a linear motion and moves the rail 261. Thereby, the Y-axis driving device 26 moves the ultrasonic probe 21 and the imaging device 24 integrated by the predetermined attachment or the like in the Y-direction.

The Z-axis driving device 27 has a rail 271 having a longitudinal direction in the Z-direction (a perpendicular direction to the XY-direction). The Z-axis driving device 27 includes a stepping motor (not shown) and a rotation-linear motion conversion mechanism (not shown) that converts the rotation motion of the stepping motor into a linear motion and moves the rail 271. Thereby, the Z-axis driving device 27 moves the ultrasonic probe 21 and the imaging device 24 integrated by the predetermined attachment or the like in the Z-direction.

Here, the water supply part 22 and the water suction part 23 may be fixed to the ultrasonic probe 21 driven by the X-axis driving device 25, the Y-axis driving device 26, and the Z-axis driving device 27, or may be moved up and down with respect to the ultrasonic probe 21 respectively independently by actuators 221, 231 shown by broken lines in FIG. 1 and predetermined driving mechanisms (second elevating devices).

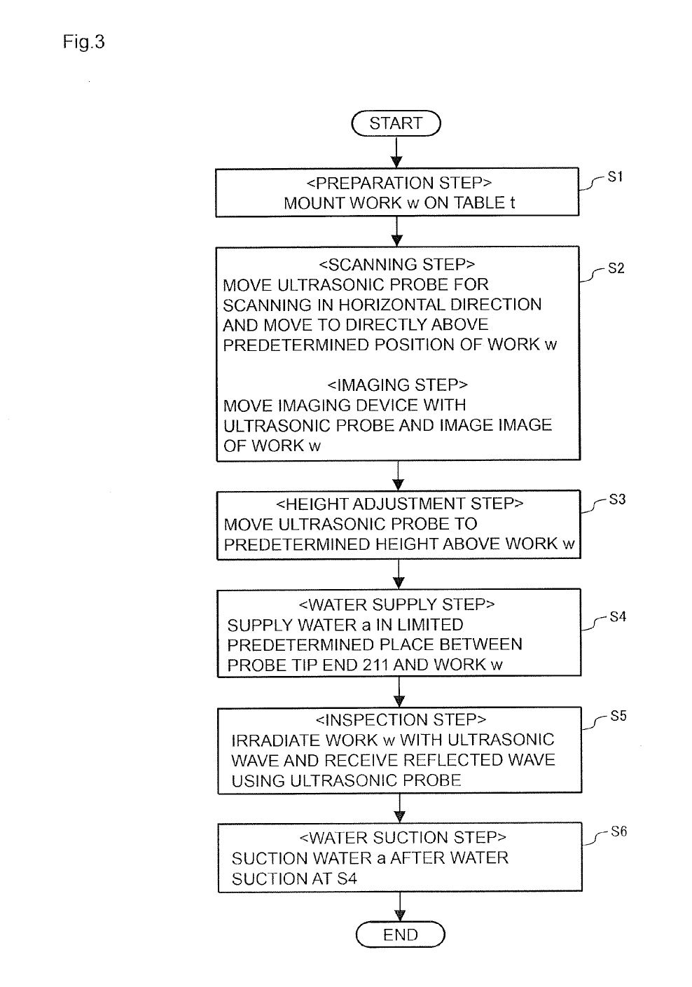

Next, an ultrasonic inspection method executed using the ultrasonic inspection apparatus 1 will be explained. FIG. 3 is a flowchart for explanation of the ultrasonic inspection method of the example.

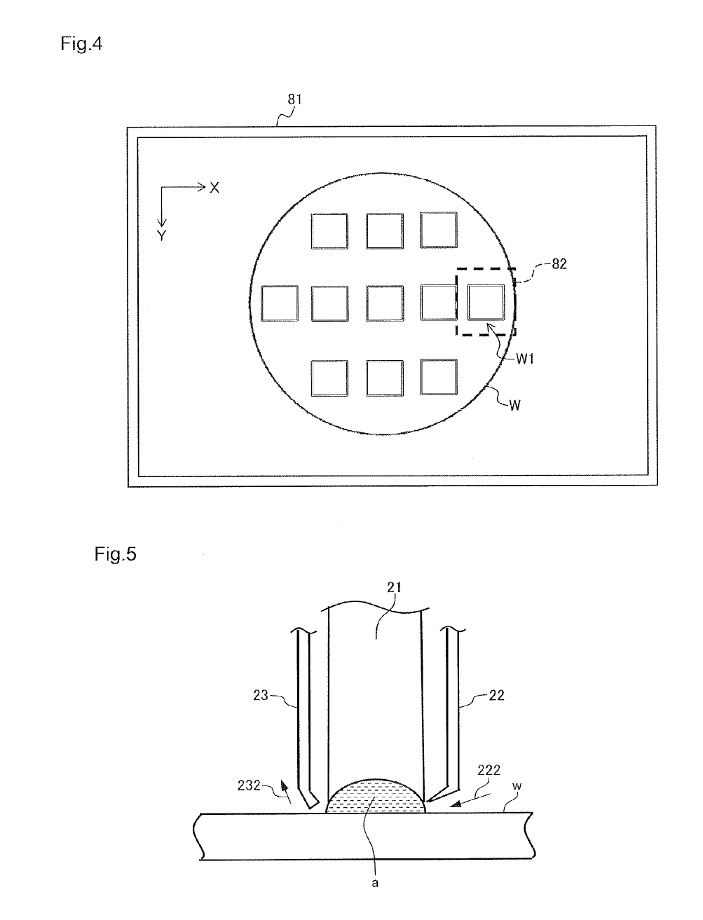

First, the work piece w is mounted on the table t placed in a predetermined position (preparation step) (S1). Then, the ultrasonic probe 21 is moved to scan the work piece w in the horizontal direction (XY-direction) by the X-axis driving device 25 and the Y-axis driving device 26 and moved to directly above the predetermined position of the work piece w (scanning step) (S2). As specific means for the movement, manual, automatic, and various kinds of means are considered. First, FIG. 4 is a plan view of a screen 81 of the display device 8. On the screen 81, the work piece (wafer) w imaged by the imaging device 24 is displayed. For example, when an inspection is desired for a chip w1 shown by a broken line 82 of the wafer w, the input device 7 may be manually operated for driving the X-axis driving device 25 and the Y-axis driving device 26 so that the target chip w1 may come to the center of the broken line 82 displayed on the screen 81. That is, the ultrasonic probe 21 is set in advance to be located directly above the chip w1 when the chip w1 comes into the broken line 82.

Alternatively, the screen 81 employs a touch panel system and coordinates of the respective parts of the screen 81 and coordinates in the X-direction and the Y-direction in which the X-axis driving device 25 and the Y-axis driving device 26 are driven may be associated with each other in advance. In other words, the scanning control part 31 may control the X-axis driving device 25 and the Y-axis driving device 26 so that, when an area shown by the broken line 82 is touched on the screen 81, the ultrasonic probe 21 may be located directly above the chip w1 of the wafer w shown by the broken line 82.

Note that, at these operations, the imaging device 24 moves with the ultrasonic probe 21 near the ultrasonic probe 21 and an imaging step of imaging an image on the work piece w side is performed (S2).

Then, the ultrasonic probe 21 is located at a predetermined height above the work piece w (height adjustment step) (S3). This may be performed by manual operation of the input device 7 to drive the Z-axis driving device 27. Alternatively, when the height of the probe tip end portion 211 of the ultrasonic probe 21 is predetermined according to the kind of work piece w, after S2, the scanning control part 31 may automatically control the Z-axis driving device 27 so that the height of the probe tip end portion 211 of the ultrasonic probe 21 may be a predetermined height.

After S2 and S3, water a in a limited predetermined amount is supplied between the probe tip end portion 211 of the ultrasonic probe 21 and (the chip w1 of) the work piece w by the water supply part 22 (water supply step) (S4). The water a in the limited predetermined amount is water in the minimum amount that can be held in close contact with the probe tip end portion 211 and the work piece w by surface tension to fill between the probe tip end portion 211 in the concave lens shape and the work piece w as shown in FIG. 5. This varies depending on the size of the probe tip end portion 211 or the like. The water supplying is performed from the tip end portion of the water supply part 22 in a direction of an arrow 222 (FIG. 5) by driving of the water supply device 61.

Then, ultrasonic wave is applied to the work piece w by the ultrasonic probe 21 and reflected wave thereof is received (inspection step) (S5). This is a flaw detection operation for the work piece w and the timing control part 34 controls the signal generation and measuring unit 4 to perform the operation by operation of the input device 7. That is, pulse wave is output to the piezoelectric element 29 of the ultrasonic probe 21 based on the timing signal output by the timing control part 34. Thereby, the piezoelectric element 29 operates and generates ultrasonic wave and the ultrasonic wave is applied from the probe tip end portion 211 to (the chip w1 of) the work piece w. Then, processing in the respective parts of the above described signal generation and measuring unit 4 is performed on the reception signal of the piezoelectric element 29 by the reflected wave, and the amplitude information of the reception signal or the time information of the reception signal is output to the image generation part 35. Then, the image generation part 35 generates an ultrasonic image at a predetermined frequency based on the output signal of the signal processing part 44. Using the image, an inspection as to whether or not flaws such as micro voids and cracks exist in (the chip w1 of) the work piece w may be performed. The flaw detection operation may be performed by moving the probe tip end portion 211 in the XY-direction in a narrow range above the chip w1.

Then, the water a after water supply at 94 is suctioned by the water suction part 23 (water suction step) (S6). The suction operation is performed from the tip end portion of the water suction part 23 in a direction of an arrow 232 (FIG. 5) by driving of the water suction device 62.

The summary of the ultrasonic inspection method is as described above. Here, as described above, the water supply part and the water suction part 23 may be mechanisms that can individually move up and down with respect to the ultrasonic probe 21 even when the parts are fixed to the ultrasonic probe 21. The operations at S4 to S6 are different between the parts and the detailed operations in the respective cases will be explained as below.

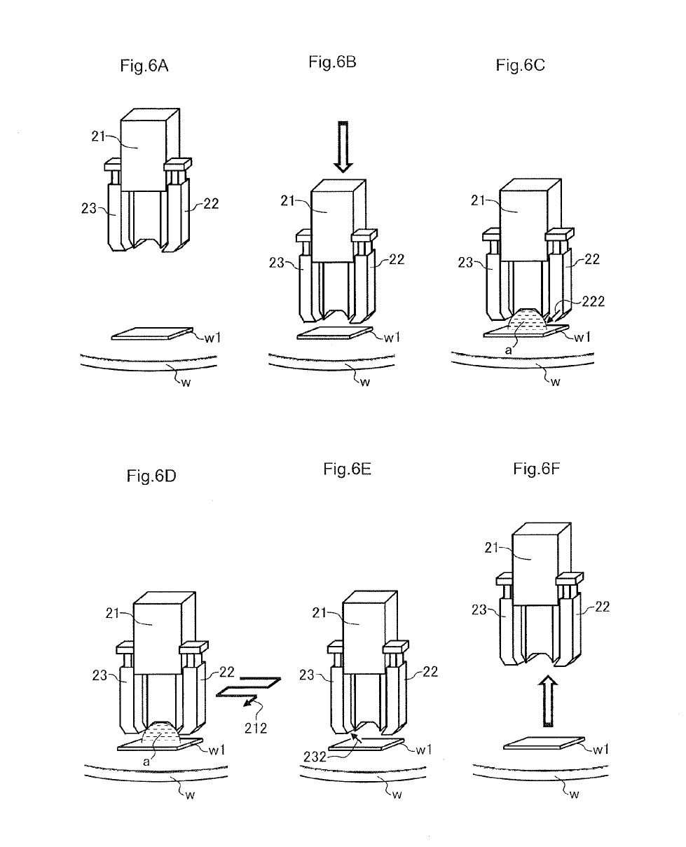

FIG. 6 is an explanatory diagram of the ultrasonic inspection method when the water supply unit 22 and the water suction unit 23 are fixed to the ultrasonic probe 21. First, at the scanning step of S2, the ultrasonic probe 21 moves to the position directly above the chip w1 (FIG. 6A). Then, at the height adjustment step of S3, the height adjustment of the ultrasonic probe 21 is performed (FIG. 6B). Then, at the water supply step of S4, the water a in the limited predetermined amount is supplied between the probe tip end portion 211 of the ultrasonic probe 21 and the chip w1 by the water supply part 22 (arrow 222) (FIG. 6C). Then, the flaw detection operation at the inspection step of S5 is performed by moving the probe tip end portion 211 in the XY-direction in the narrow range above the chip w1 (shown by the arrow 212) (FIG. 6D). Then, at the water suction step of S6, the operation of supplying the water a is performed by the water suction part 23 (arrow 232) (FIG. 6E). Then, the ultrasonic probe 21 is moved up by the Z-axis driving device 27 and the series of processing is ended (FIG. 6F).

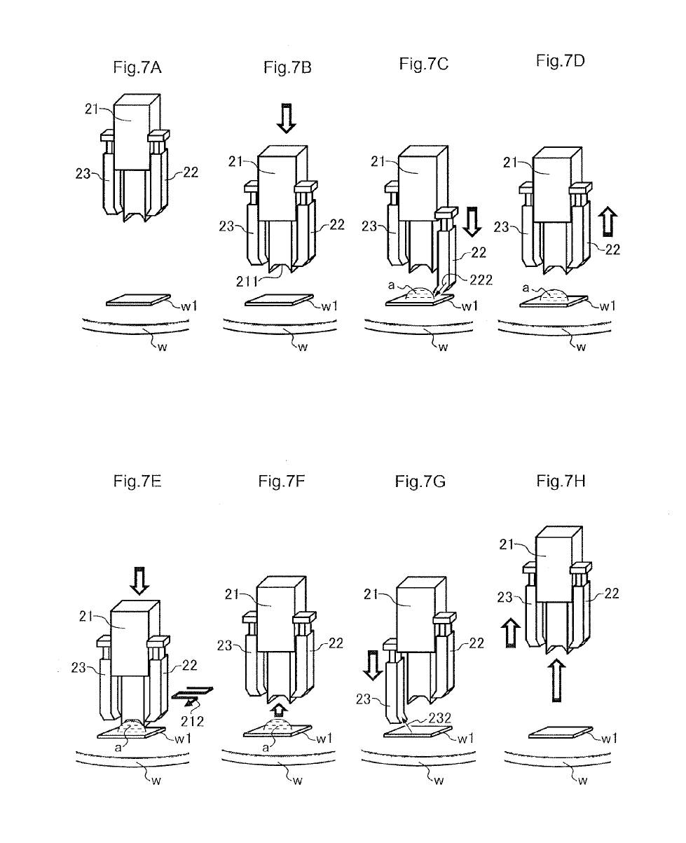

FIG. 7 is an explanatory diagram of the ultrasonic inspection method when the water supply part 22 and the water suction part 22 can individually move up and down with respect to the ultrasonic probe 21. First, at the scanning step of S2, the ultrasonic probe 21 moves to the position directly above the chip w1 (FIG. 7A). Then, at the height adjustment step of S3, the height adjustment of the ultrasonic probe 21 is performed (FIG. 7B). Thereby, the probe tip end portion 211 of the ultrasonic probe 21 is moved down closer to the chip w1 to some degree. Then, the actuator 221 is operated to move down the tip end portion of the water supply part 22 closer to the chip w1 and, at the water supply step of S4, the water a is supplied onto the chip w1 (arrow 222) (FIG. 7C). Then, the actuator 221 is operated to move up the water supply part 22 and return the part to the position before the operation in FIG. 7C (FIG. 7D). Then, the flaw detection operation at the inspection step of S5 is performed by moving the probe tip end portion 211 in the XY-direction in the narrow range above the chip w1 with the probe tip end portion 211 pressed against the water a (arrow 212) (FIG. 7E). Then, the ultrasonic probe 21 is returned to the position after the operation in FIG. 7B (FIG. 7F). Then, the actuator 231 is operated to move down the water suction part 23 and the water a is suctioned by the water suction part 23 (arrow 232) (FIG. 7G). Then, the ultrasonic probe 21 is moved up by the Z-axis driving device 27 and the series of processing is ended (FIG. 7H).

According to the above described ultrasonic inspection apparatus 1 and ultrasonic inspection method, the water a supplied from the water supply part 22 is in the limited predetermined amount and suctioned by the water suction part 23 after the flaw detection operation. Accordingly, local immersion limited to the range of the chip w1 is maintained and the chips around the chip w1 are not immersed in the water. Further, the chip w1 is immersed not for a long period. Therefore, immersion in water of the work piece w that should avoid water in a wide range for a long period may be prevented.

Further, it is possible that another object than the water a does not intervene between the probe tip end portion 211 and the work piece w, and a good image may be obtained in the ultrasonic inspection.

In addition, the imaging device 24 is moved with the ultrasonic probe 21, and thereby, the scanning step (S2) of the ultrasonic probe 21 is easier.

Further, in the example with reference to FIG. 7, supply of the water a to a proper position and then proper removal of the water a are easier.

Furthermore, the probe tip end portion 211 has the concave lens shape, and thus, the range of the water a mounted on the chip w1 may be made narrower by surface tension.

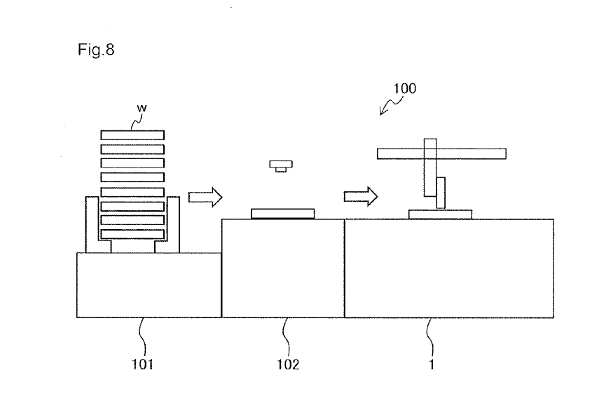

The above described ultrasonic inspection apparatus 1 is explained on the assumption of the stand-alone apparatus independent of another system, however, the ultrasonic inspection apparatus 1 can be incorporated into the manufacturing line of the work piece w. When the ultrasonic inspection apparatus 1 is incorporated into the manufacturing line of the work piece w, a configuration of an ultrasonic inspection system 100 as shown in FIG. 8 is desirable.

That is, as shown in FIG. 8, the ultrasonic inspection system 100 includes a work piece mounting table 101 on which a plurality of work pieces w manufactured through a manufacturing line of the work pieces w e.g. a semiconductor device manufacturing process line are mounted, the above described ultrasonic inspection apparatus 1, and an alignment apparatus 102 that sequentially positions and supplies the work pieces w mounted on the work piece mounting table 101 to the ultrasonic inspection apparatus 1. The ultrasonic inspection system 100 is incorporated into the manufacturing line of the work pieces w (when the work piece w is a semiconductor device, at the step before dicing of the work piece w into individual pieces of chips).

In this case, all work pieces w are constantly mounted in fixed positions on a plate t by the alignment apparatus 102. Further, the data processing unit 3 holds shape data (CAD (Computer Aided Design) data or the like) of the work piece w, and the ultrasonic probe 21 is moved to the predetermined position of the chip w1 based on the shape data under the control of the scanning control part 31. Regarding the series of other operations, the operations of the ultrasonic inspection apparatus 1 are automated.

Note that, in the above described ultrasonic inspection apparatus 1, the ultrasonic inspection may be performed as sampling inspection such that only part of the work pieces w (several chips of one wafer) are inspected, and the part (chip w1) that has been inspected may be discarded and only the parts that have not been inspected may be shipped as products.

The teachings are not limited to the above described examples, but includes various modified examples. For example, the above described examples are explained in detail for an easy-to-understand explanation of the teachings, and the teachings are not necessarily limited to one having all of the described configurations. Further, a part of a configuration of a certain example can be replaced by a configuration of another example and a configuration of another example can be added to a configuration of a certain example. Furthermore, addition, elimination, replacement of another configuration can be made to a part of a configuration of each example.

In addition, part or all of the above described respective configurations, functions, processing units, processing means, etc. may be realized using hardware by e.g. design using an integrated circuit. The above described respective configurations, functions, etc. may be realized using software by a processor interpreting and realizing programs for realizing the respective functions. Information of the programs, tables, files, etc. for realizing the respective functions may be placed in a memory, a recording device such as a hard disk or an SSD (Solid State Drive), or a recording medium such as an IC card, an SD card, or a DVD.

Control lines and information lines considered to be necessary for explanation are shown, but not all control lines and information lines for products are necessarily shown. In practice, it may be considered that almost all configurations are connected to one another.

### DESCRIPTION OF REFERENCE SIGNS

1 ultrasonic inspection apparatus
21 ultrasonic probe
22 water supply part
23 water suction part
24 imaging device
25 X-axis driving device (scanning device)
26 Y-axis driving device (scanning device)
27 Z-axis driving device (first elevating device)
28 ENCODER
3 DATA PROCESSING UNIT
31 SCANNING CONTROL PART
32 WATER SUPPLY AND WATER SUCTION CONTROL PART
33 IMAGING CONTROL PROCESSING PART
34 TIMING CONTROL PART
35 IMAGE GENERATION PART
4 SIGNAL GENERATION AND MEASURING UNIT
41 PULSE GENERATOR
43 A/D CONVERTER
44 SIGNAL PROCESSING PART
5 DRIVING UNIT
6 DRIVING UNIT
61 WATER SUPPLY DEVICE
62 WATER SUCTION DEVICE
63 DRIVING PART
7 INPUT DEVICE
8 DISPLAY DEVICE
101 work piece mounting table
102 alignment apparatus
211 probe tip end portion
221 actuator (second elevating device)
231 actuator (second elevating device)
S2 scanning step, imaging step
S3 height adjustment step
S4 water supply step
S5 inspection step
S6 water suction step

What is claimed is:

1. An ultrasonic inspection apparatus comprising:
an ultrasonic probe that irradiates a work piece with ultrasonic wave and receives reflected wave thereof;
a scanning device that allows the ultrasonic probe to scan the work piece in a horizontal direction;
a first elevating device that moves up and down the ultrasonic probe with respect to the work piece;
a water supply part provided in a side part of the ultrasonic probe and, after a probe tip end portion having a concave lens shape of the ultrasonic probe is moved to directly above a predetermined position of the work piece, supplying water in a minimum limited predetermined amount that can be held in close contact with the probe tip end portion and the work piece by surface tension to fill between the probe and the work piece; and
a water suction part provided in a side part of the ultrasonic probe and suctioning water after water supply by the water supply part.

2. The ultrasonic inspection apparatus according to claim 1, wherein the work piece includes a plurality of chips, and
after the probe tip end portion of the ultrasonic probe is moved to directly above the chip to be inspected, the water supply part supplies water limited to a range of the chip to be inspected.

3. The ultrasonic inspection apparatus according to claim 1, further comprising a second elevating device that moves up and down the water supply part and the water suction part respectively independently with respect to the ultrasonic probe,
wherein the second elevating device moves down the water supply part from the ultrasonic probe toward the work piece side and supplies water, then, moves up the water supply part toward the ultrasonic probe side,
then, the ultrasonic probe irradiates the work piece with ultrasonic wave and receives reflected wave thereof,
then, the second elevating device moves down the water suction part from the ultrasonic probe toward the work piece side and suctions the water, and then, moves up the water suction part toward the ultrasonic probe side.

4. The ultrasonic inspection apparatus according to claim 1, further comprising an imaging device that moves with the ultrasonic probe near the ultrasonic probe and images an image on the work piece side.

5. The ultrasonic inspection apparatus according to claim 4, further comprising a scanning control part that controls the scanning device based on the image imaged by the imaging device and moves the probe tip end portion of the ultrasonic probe to directly above a predetermined position of the work piece.

6. An ultrasonic inspection system comprising:
a work piece mounting table on which a plurality of work pieces are mounted;
the ultrasonic inspection apparatus according to claim 1; and
an alignment apparatus that sequentially positions and supplies the work pieces mounted on the work piece mounting table to the ultrasonic inspection apparatus.

7. An ultrasonic inspection method comprising:
a scanning step of moving an ultrasonic probe that irradiates a work piece with ultrasonic wave and receives reflected wave thereof to scan the work piece in a horizontal direction and moving the probe to directly above a predetermined position of the work piece;
a height adjustment step of positioning the ultrasonic probe at a predetermined height above the work piece;
a water supply step of supplying minimum water that can be held in close contact with the probe tip end portion and the work piece by surface tension to fill between the probe and the work piece after a probe tip end portion having a concave lens shape of the ultrasonic probe is moved to directly above a predetermined position of the work piece after the scanning step and the height adjustment step;
an inspection step of irradiating the work piece with ultrasonic wave using the ultrasonic probe and receiving reflected wave thereof after the water supply step; and
a water suction step of suctioning the water after water supply at the water supply step.

8. The ultrasonic inspection method according to claim 7, wherein the work piece includes a plurality of chips,
at the scanning step, the probe tip end portion of the ultrasonic probe is moved to directly above the chip to be inspected, and
at the water supply step, water limited to a range of the chip to be inspected is supplied.

9. The ultrasonic inspection method according to claim 7, wherein the water supply step is performed after a water supply part that supplies the water is moved down from the ultrasonic probe toward the work piece side, and then, the water supply part is moved up toward the ultrasonic probe side, and
the water suction step is performed after a water suction part that suctions the water is moved down from the ultrasonic probe toward the work piece side, and then, the water suction part is moved up toward the ultrasonic probe side.

10. The ultrasonic inspection method according to claim 7, further comprising an imaging step of imaging an image of the work piece,
wherein the scanning step moves the ultrasonic probe based on the image imaged at the imaging step.
